(19) United States
(12) Patent Application Publication
(10) Pub. No.: US 2009/0102333 A1
(43) Pub. Date: Apr. 23, 2009

(54) ANTISLIP DRAWER-CHUCKING STRUCTURE

(76) Inventor: Kuo-Chan WENG, Tuku Chen (TW)

Correspondence Address: SINORICA, LLC, 528 FALLSGROVE DRIVE, ROCKVILLE, MD, 20850, US

(21) Appl. No.: 12/250,853

(22) Filed: Oct. 14, 2008

(30) Foreign Application Priority Data
Oct. 18, 2007 (TW) 096217459

(51) Int. Cl. E05C 19/02; E05C 21/02

(52) U.S. Cl. 312/222; 292/300

(57) ABSTRACT

An antislip drawer-chucking structure includes a cabinet body, at least one drawer and a chucking unit. The drawer can be slid and drawn out of and pushed into the cabinet body. The chucking unit includes a shift member, a first engaging section and a second engaging section. The shift member is disposed on outer face of the front board of the drawer, including a handle section and a shift section. The handle section is fixed on the drawer. The shift section is positioned between the handle section and the drawer and movable between a first position and a second position. The first engaging section is arranged at one end of the shift section. The second engaging section is arranged on the cabinet body corresponding to the first engaging section. When the drawer is fully pushed into the cabinet and the shift section is positioned in the first position, the first and second engaging sections are engaged with each other. When the drawer is fully pushed into the cabinet and the shift section is positioned in the second position, the first and second engaging sections are disengaged from each other.

### BACKGROUND OF THE INVENTION

The present invention is related to a chucking structure serving to prevent two relatively slidable articles from slipping, and more particularly to a chucking structure for preventing the drawers of a file cabinet or tool cabinet from unexpectedly sliding out of the cabinet.

A conventional file cabinet or tool cabinet is substantially composed of several wallboards which define a rectangular solid internal space. The internal space has a front opening. Several drawers are arranged in the internal space from upper side to lower side for placing papers or tools therein. In order to smoothly draw out and push in the drawers, slide rails are respectively mounted between the cabinet and the drawers. Moreover, ball bearings are laid between the slide rails for more easily drawing out and pushing in the drawers without causing noise.

In case that the file cabinet or tool cabinet is rested on an inclined ground or tilted, it often takes place that the drawers themselves slide out of the cabinet or even drop onto the ground. This leads to inconvenience and is dangerous.

### SUMMARY OF THE INVENTION

It is therefore a primary object of the present invention to provide an antislip drawer-chucking structure for the drawers of a file cabinet or tool cabinet. In case that the file cabinet or tool cabinet is rested on an inclined ground or tilted, the antislip drawer-chucking structure prevents the drawers of the file cabinet or tool cabinet from unexpectedly sliding out of the cabinet. The drawers can be conveniently released from the drawer-chucking structure as necessary.

According to the above object, the antislip drawer-chucking structure of the present invention includes a cabinet body, at least one drawer and a chucking unit. The drawer can be slid and drawn out of and pushed into the cabinet body. The chucking unit includes a shift member, a first engaging section and a second engaging section. The shift member is disposed on outer face of the front board of the drawer, including a handle section and a shift section. The handle section is fixed on the drawer. The shift section is positioned between the handle section and the drawer and movable between a first position and a second position. The first engaging section is arranged at one end of the shift section. The second engaging section is arranged on the cabinet body corresponding to the first engaging section.

The present invention can be best understood through the following description and accompanying drawings wherein:

### BRIEF DESCRIPTION OF THE DRAWINGS

FIG. 1 is a perspective view of a first embodiment of the present invention;

FIG. 2 is a perspective view of the drawer of the first embodiment of the present invention;

FIG. 2A is an enlarged view of circled area A of FIG. 2;

FIG. 3 is a perspective view of a part of the first embodiment of the present invention;

FIG. 4 is a perspective view according to FIG. 3, showing that a force is applied to a drawer;

FIG. 5 is a perspective view according to FIG. 4, showing that the drawer is drawn out;

FIG. 6 is a perspective view of a part of a second embodiment of the present invention;

FIG. 7 is a perspective view of still a part of the second embodiment of the present invention;

FIG. 8 is a perspective view of a part of a third embodiment of the present invention;

FIG. 9 is a perspective view of still a part of the third embodiment of the present invention;

FIG. 10 is a perspective view of a part of a drawer of a fourth embodiment of the present invention; and

FIG. 11 is a perspective view of a part of the fourth embodiment of the present invention.

### DETAILED DESCRIPTION OF THE PREFERRED EMBODIMENTS

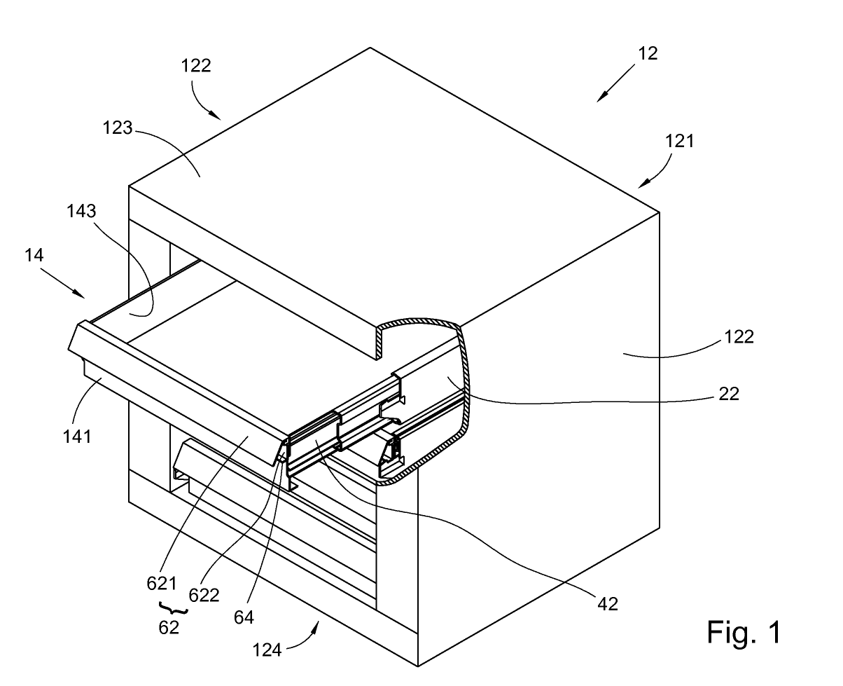

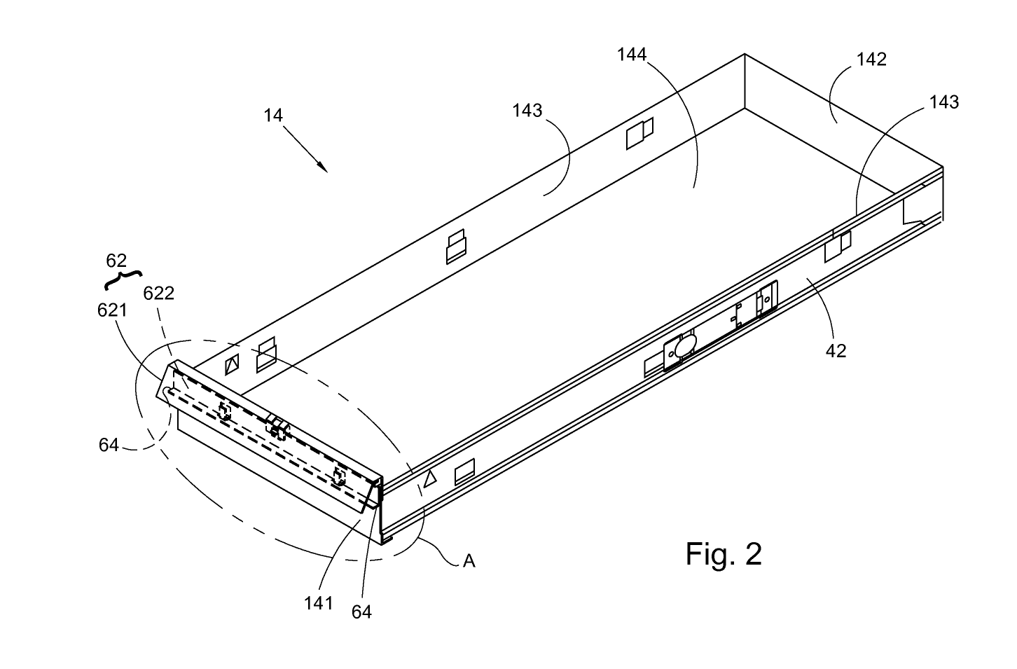

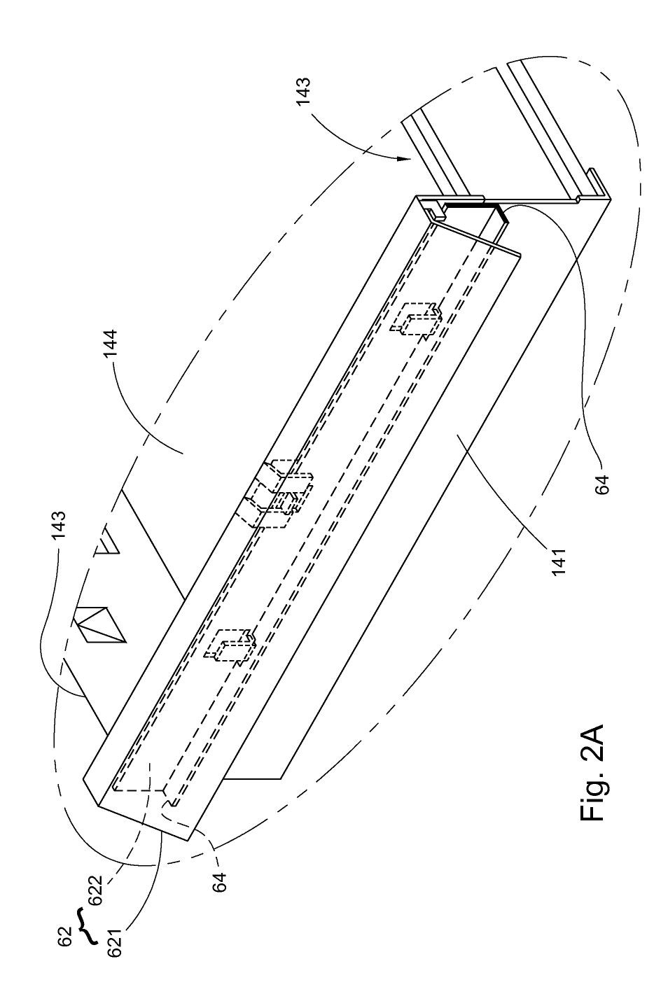

Please refer to FIGS. 1 to 5. The antislip drawer-chucking structure of the present invention includes a cabinet body 12, at least one drawer 14 and a chucking unit 16.

The cabinet body 12 is composed of a rear board 121, two sideboards 122, an upper board 123 and a lower board 124 which define a rectangular solid internal space. The cabinet body 12 has a front opening. A first slide section 22 such as a cabinet slide rail is fixedly mounted on inner face of each sideboard 122 of the cabinet body 12.

The drawer 14 is composed of a front board 141, a rear board 142, two sideboards 143 and a lower board 144 which define a rectangular solid internal space. The drawer 14 has an upper opening. A second slide section such as a drawer slide rail is fixedly mounted on outer face of each sideboard 143 of the drawer 14. The second slide section 42 is slidably fitted in the first slide section 22, whereby the drawer 14 can be slid and drawn out of and pushed into the cabinet body 12.

The chucking unit 16 includes a shift member 62, a first engaging section 64 and a second engaging section 66.

The shift member 62 is disposed on outer face of the front board 141 of the drawer 14, including a handle section 621 and a shift section 622. The handle section 621 is fixed on the drawer 14. The shift section 622 is up and down movably positioned between the handle section 621 and the drawer 14.

The first engaging section 64 is arranged at one end or two ends of the shift section 622.

The second engaging section 66 is arranged on the cabinet body 12 such as at outer end of the first slide section 22 corresponding to the first engaging section 64. The second engaging section 66 can be a sectional face. When the drawer 14 is fully pushed into the cabinet 12 and the shift section 622 is positioned in a lower position, the first and second engaging sections 64, 66 are engaged with each other. When the drawer 14 is fully pushed into the cabinet 12 and the shift section 622 is positioned in an upper position, the first and second engaging sections 64, 66 are disengaged from each other.

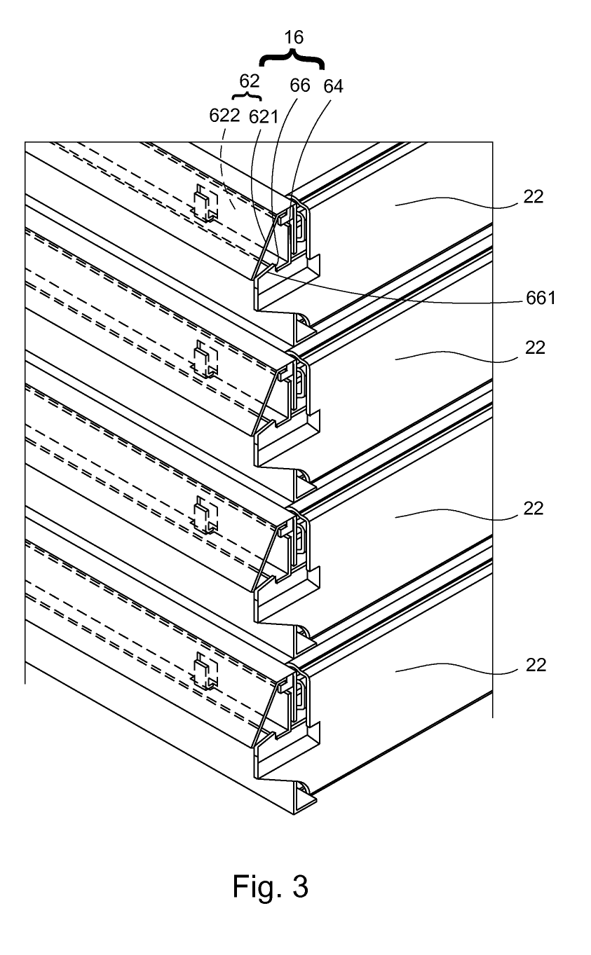

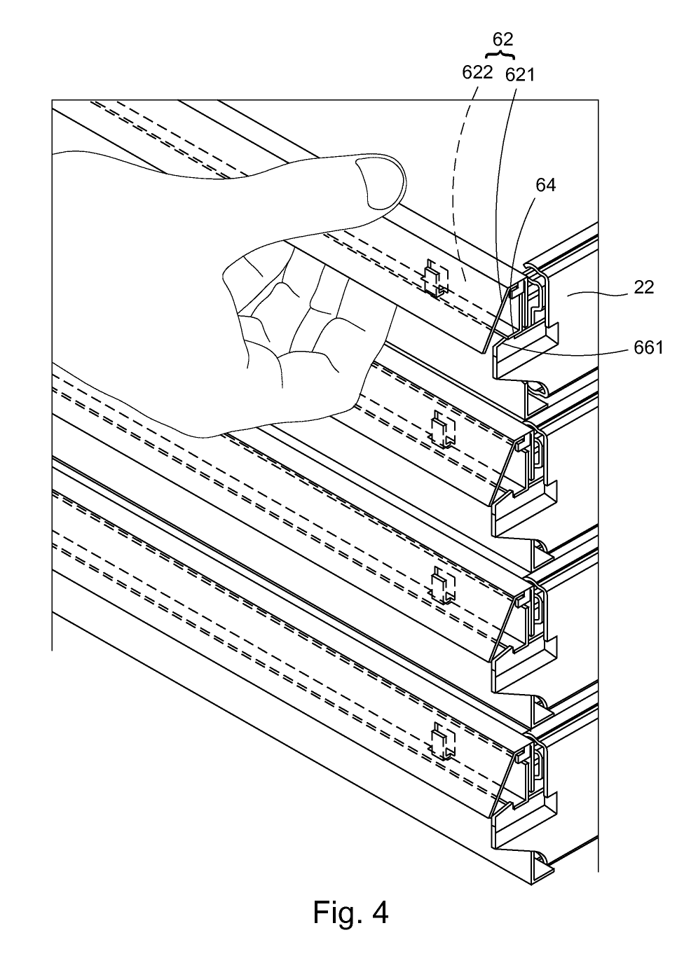

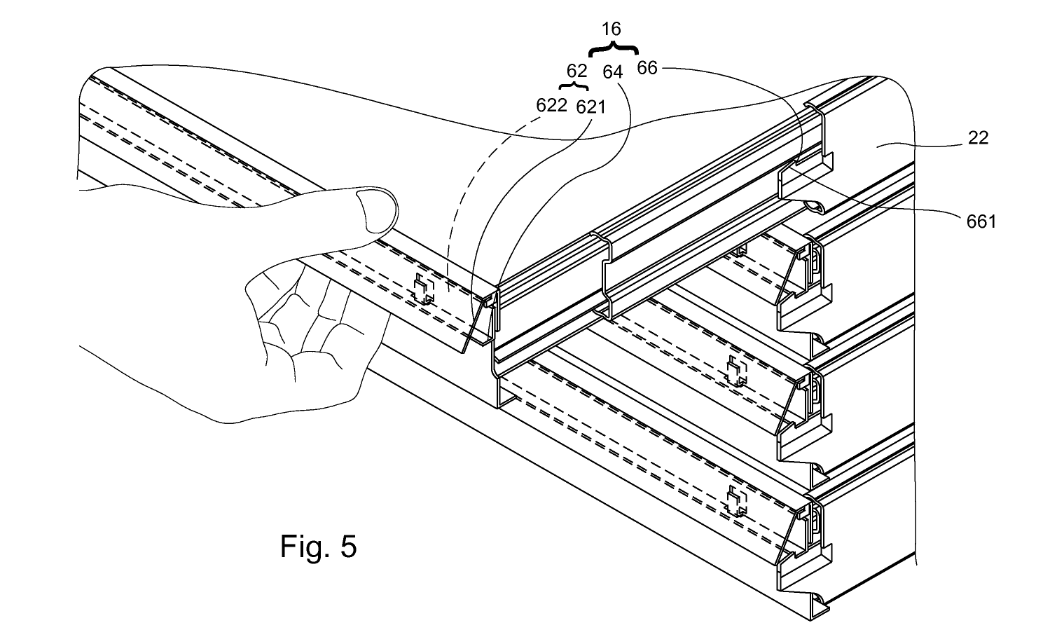

According to the above arrangement, when the drawer 14 is pushed into the cabinet body 12, due to gravity, the shift section 622 is positioned in the lower position. At this time, the first and second engaging sections 64, 66 are engaged with each other as shown in FIG. 3. Under such circumstance, the drawer 14 will not slip out of the cabinet body 12. Referring to FIGS. 4 and 5, a user can manually shift the shift section 622 from the lower position to the upper position. At this time, the first and second engaging sections 64, 66 are disengaged from each other, whereby the drawer 14 can be smoothly drawn out or pushed in.

Moreover, an upper end of the sectional face is formed with a downward extending guide slope 661. Accordingly, even if the shift section 622 is not manually shifted, the shift section 622 can be also smoothly moved from the lower position to the upper position, permitting the drawer 14 to be pushed into the cabinet body 12.

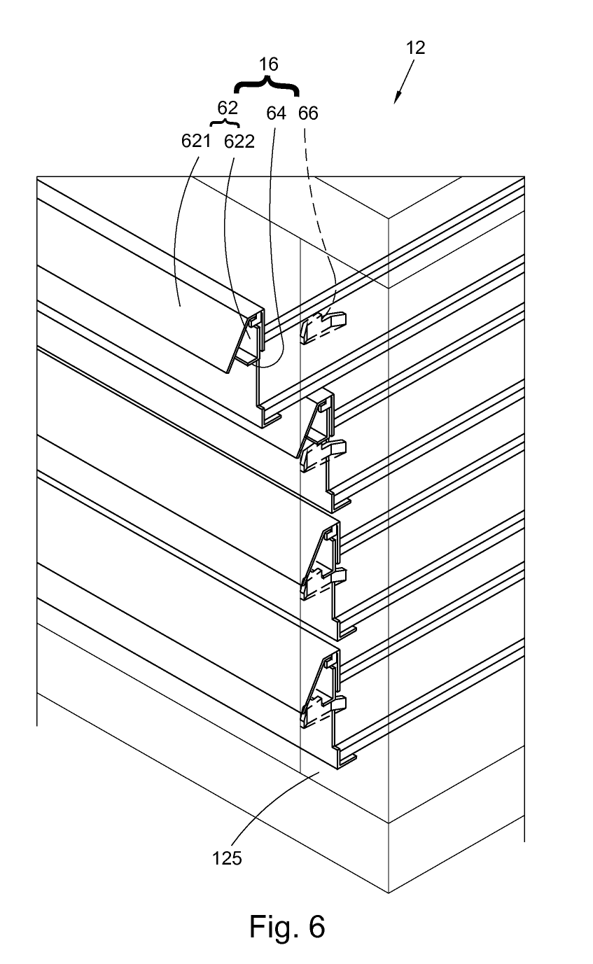

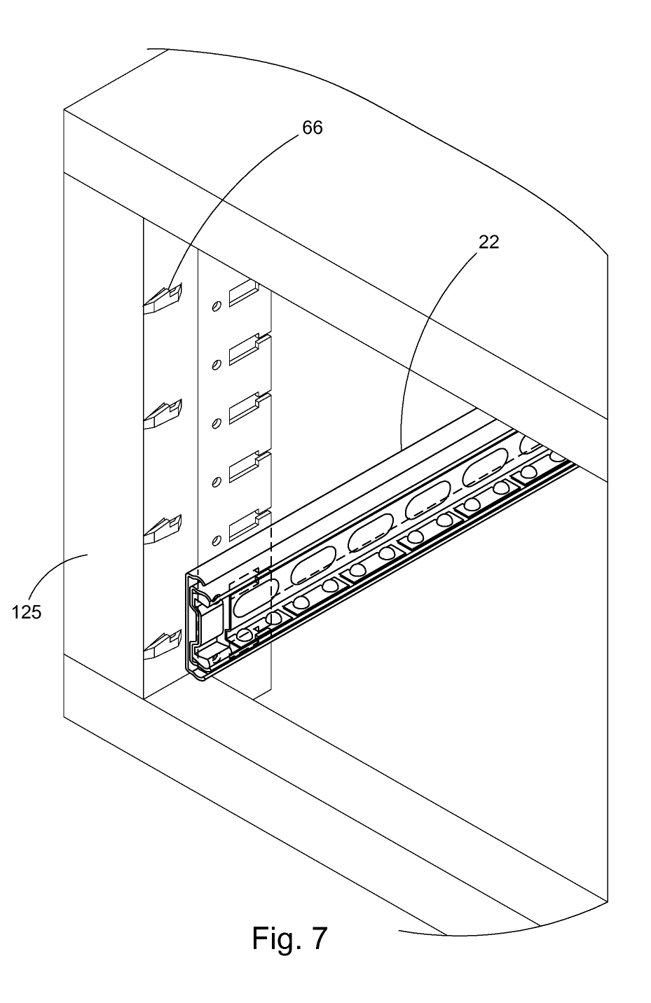

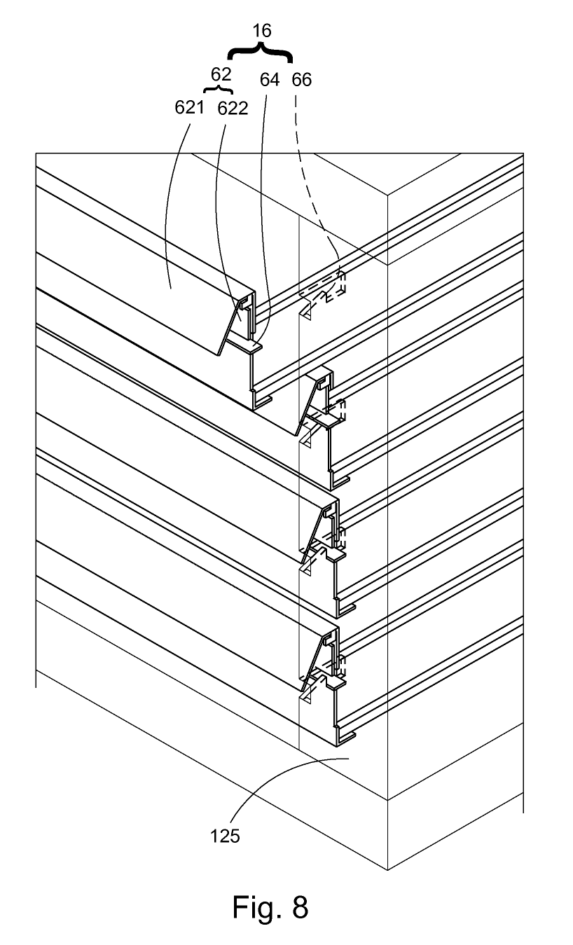

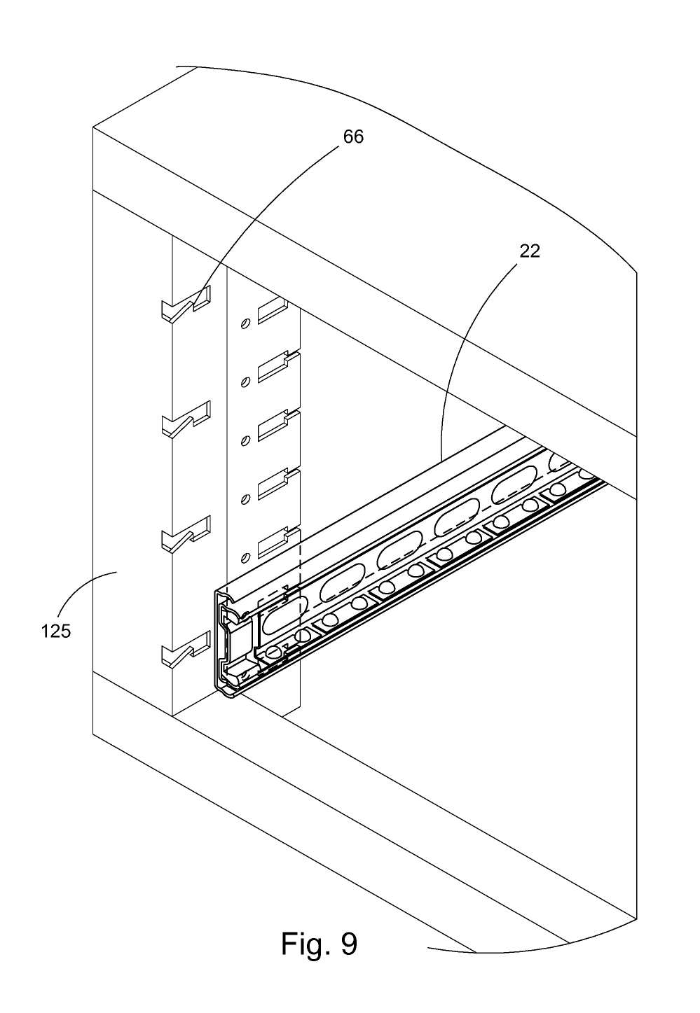

Moreover, referring to FIGS. 6 to 9, the cabinet body 12 further includes two columns 125 respectively arranged on two sides of the front opening of the cabinet body 12. The second engaging sections 66 are disposed on the two columns 125 to achieve the same effect. FIGS. 6 and 7 show a preferred embodiment of the present invention, while FIGS. 8 and 9 show another embodiment thereof.

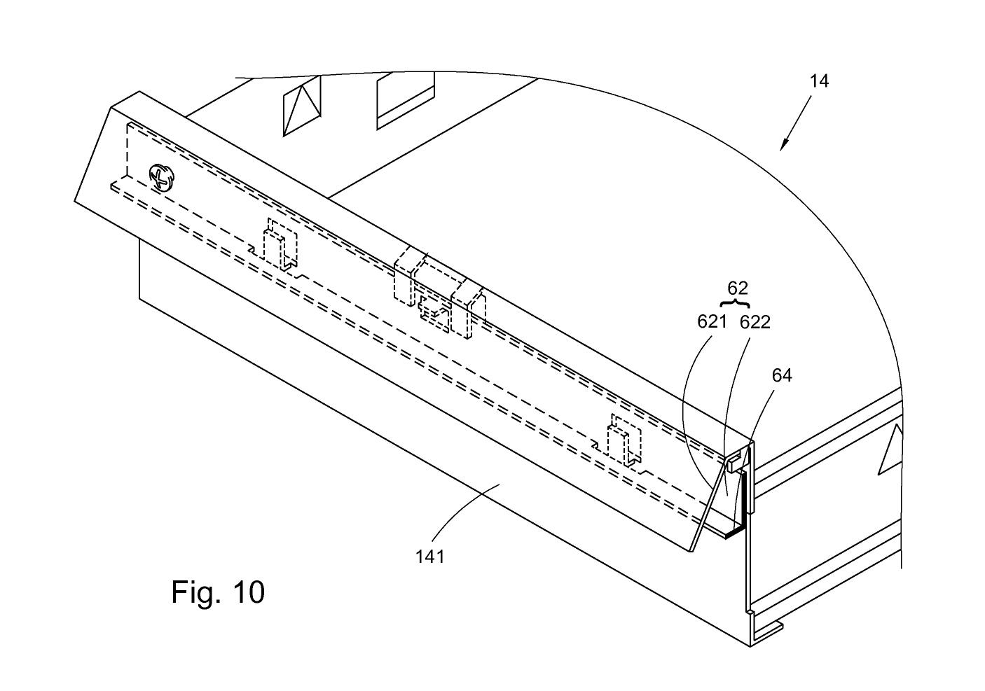

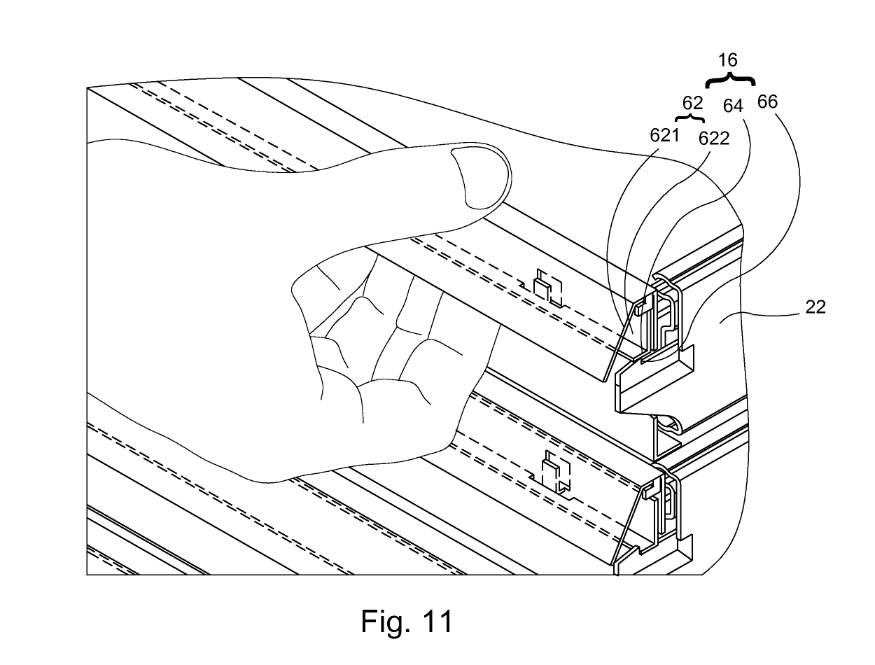

Referring to FIGS. 10 and 11, one side of the shift section 622 is formed with the first engaging section 64, while another side of the shift section 622 is pivotally connected with the front board 141 of the drawer 14. Accordingly, the shift section 622 is angularly movable between an upper position and a lower position. This can also engage the first and second engaging sections 64, 66 with each other or disengage the first and second engaging sections 64, 66 from each other.

The above embodiments are only used to illustrate the present invention, not intended to limit the scope thereof. Many modifications of the above embodiments can be made without departing from the spirit of the present invention.

What is claimed is:

1. An antislip drawer-chucking structure comprising:
a cabinet body composed of a rear board, two sideboards, an upper board and a lower board which define a rectangular solid internal space, the cabinet body having a front opening, the cabinet body further having a first slide section fixedly mounted on inner face of each sideboard of the cabinet body;
at least one drawer composed of a front board, a rear board, two sideboards and a lower board which define a rectangular solid internal space, the drawer having an upper opening, a second slide section being fixedly mounted on outer face of each sideboard of the drawer, the second slide section being slidably fitted in the first slide section, whereby the drawer can be slid and drawn out of and pushed into the cabinet body; and
a chucking unit including a shift member, a first engaging section and a second engaging section, the shift member being disposed on outer face of the front board of the drawer, the shift member including a handle section and a shift section, the handle section being fixed on the drawer, the shift section being positioned between the handle section and the drawer and movable between a first position and a second position, the first engaging section being arranged at one end of the shift section, the second engaging section being arranged on the cabinet body corresponding to the first engaging section, whereby when the drawer is pushed into the cabinet and the shift section is positioned in the first position, the first and second engaging sections are engaged with each other, while when the drawer is pushed into the cabinet and the shift section is positioned in the second position, the first and second engaging sections are disengaged from each other.

2. The antislip drawer-chucking structure as claimed in claim 1, wherein the shift section is up and down movable between the first and second positions.

3. The antislip drawer-chucking structure as claimed in claim 1, wherein one side of the shift section is pivotally connected with the front board of the drawer, whereby the shift section is angularly movable between the first and second positions.

4. The antislip drawer-chucking structure as claimed in claim 1, wherein the first slide section is a slide rail and the second engaging section is a sectional face formed on outer end of the slide rail.

5. The antislip drawer-chucking structure as claimed in claim 2, wherein the first slide section is a slide rail and the second engaging section is a sectional face formed on outer end of the slide rail.

6. The antislip drawer-chucking structure as claimed in claim 3, wherein the first slide section is a slide rail and the second engaging section is a sectional face formed on outer end of the slide rail.

7. The antislip drawer-chucking structure as claimed in claim 4, wherein the second engaging section has a guide slope adjacent to the sectional face, whereby when the drawer is pushed into the cabinet body, the guide slope serves to guide the first engaging section to move toward the second position.

8. The antislip drawer-chucking structure as claimed in claim 5, wherein the second engaging section has a guide slope adjacent to the sectional face, whereby when the drawer is pushed into the cabinet body, the guide slope serves to guide the first engaging section to move toward the second position.

9. The antislip drawer-chucking structure as claimed in claim 6, wherein the second engaging section has a guide slope adjacent to the sectional face, whereby when the drawer is pushed into the cabinet body, the guide slope serves to guide the first engaging section to move toward the second position.

10. The antislip drawer-chucking structure as claimed in claim 1, wherein the cabinet body further includes at least one column arranged on one side of the front opening of the cabinet body, the second engaging sections being a sectional face disposed on the column.

11. The antislip drawer-chucking structure as claimed in claim 2, wherein the cabinet body further includes at least one column arranged on one side of the front opening of the cabinet body, the second engaging sections being a sectional face disposed on the column.

12. The antislip drawer-chucking structure as claimed in claim 3, wherein the cabinet body further includes at least one column arranged on one side of the front opening of the cabinet body, the second engaging sections being a sectional face disposed on the column.

13. The antislip drawer-chucking structure as claimed in claim 10, wherein the second engaging section has a guide slope adjacent to the sectional face, whereby when the drawer is pushed into the cabinet body, the guide slope serves to guide the first engaging section to move toward the second position.

14. The antislip drawer-chucking structure as claimed in claim 11, wherein the second engaging section has a guide slope adjacent to the sectional face, whereby when the drawer is pushed into the cabinet body, the guide slope serves to guide the first engaging section to move toward the second position.

15. The antislip drawer-chucking structure as claimed in claim 12, wherein the second engaging section has a guide slope adjacent to the sectional face, whereby when the drawer is pushed into the cabinet body, the guide slope serves to guide the first engaging section to move toward the second position.
